(19) United States
(12) Patent Application Publication
(10) Pub. No.: US 2019/0064390 A1
(43) Pub. Date: Feb. 28, 2019

(54) SYSTEM AND METHOD FOR PRODUCING HYDROCARBONS FROM SUBSURFACE RESERVOIRS BASED ON KINETICS DESIGNED FOR IMPROVED API GRAVITY PREDICTION

(71) Applicant: CHEVRON U.S.A. INC., San Ramon, CA (US)

(72) Inventor: Friedemann Ulrich Maximilian BAUR, Houston, TX (US)

(21) Appl. No.: 16/115,729

(22) Filed: Aug. 29, 2018

Related U.S. Application Data
(60) Provisional application No. 62/552,440, filed on Aug. 31, 2017.

(51) Int. Cl. G01V 99/00; E21B 49/08

(52) U.S. Cl. CPC G01V 99/005; E21B 49/087

(57) ABSTRACT

A method is described for calculating kinetics of the API gravity predictions used for calculations related to the related to predictions of hydrocarbon properties in order to better facilitate the production of hydrocarbons from subsurface reservoirs. The method may be executed by a computer system.

### CROSS-REFERENCE TO RELATED APPLICATIONS

The present application claims the priority benefit of U.S. Provisional Application Ser. No. 62/552,440, filed on Aug. 31, 2017, which is incorporated herein by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for improved production of hydrocarbons from hydrocarbon reservoirs in the earth's subsurface and, in particular, accounting for the proper kinetics of the API (American Petroleum Institute) gravity predictions used for calculations related to predictions of hydrocarbon properties.

### BACKGROUND

Hydrocarbon production (the process of extracting hydrocarbons from subsurface reservoirs) begins with a regional analysis including basin modeling. An important part of the process is determining the likely type, if any, of the hydrocarbons in a given basin. This involves prediction of GOR (gas-oil ratio), CGR (condensate-gas ratio), and API gravity (quality of the hydrocarbon). Hydrocarbon API gravity predictions using kinetics in combination with the basin modeling approach revealed poor matches between modelled predictions and observed data (Baur et al, 2011). The reason for this are inappropriate primary and secondary cracking schemes combined with unsuitable adsorption models within the same kinetics. Also, research in the past focused mainly on GOR and phase predictions. Mathematical descriptions (kinetics) of how oil and gas are generated, cracked, adsorbed and expelled in and from a source rock need to be implemented into basin modeling software to make API and GOR predictions (for example, FIG. 1). Most publicly available kinetics do not predict increasing API gravity trends with increasing maturity but instead reveal no or even inverted correlations.

When bulk or two component kinetics are used in basin modeling, fixed relationships between API gravity and source rock maturity are typically applied to predict APIs. However, those predictions are not kinetically derived, where components of different densities are generated and expelled from the source rock and the API gravity is a consequence of the relative mixing. Tang (2011) offered three kinetics (for source rock type I, II and III), which predict the correct API trends but are not adjustable to match specific known source rock characteristics due to extreme complex secondary cracking schemes.

Only one available kinetic exist (Type II Woodford SLB proprietary), which is capable to predict API in a geologically reasonable and is easy enough “designed” so that a fine tuning of API is possible. This kinetic does not use adsorption and cannot be applied to unconventional settings.

The ability to predict the correct API gravity of hydrocarbons in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for production of hydrocarbons from hydrocarbon reservoirs in the earth's subsurface and, in particular, accounting for the proper kinetics of the API gravity predictions used for calculations related to the related to predictions of hydrocarbon properties.

### SUMMARY

In accordance with some embodiments, a method of predicting API gravity in a subsurface reservoir is disclosed. The present invention creates 5 new kinetics (one for each kerogen type (A-IIS), (B-II), (C-I), (DE-II-III), (F-IV)), which are able to predict API in a geologically reasonable way and are easy to manipulate (change API up or down if necessary). In addition, the kinetics use adsorption schemes for the active kerogen so that they can be used for unconventional assessments. These are universally applicable kinetics that contain only 4 pseudo-components to optimize and simplify computation and editing, allowing the generation of robust and geologically reasonable API, GOR, and CGR ranges.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIGS. 1-3 demonstrate prior art methods of API and/or GOR predictions;

FIG. 4 illustrates a flowchart of a method of predicting API gravity, in accordance with some embodiments; and

FIG. 5 is a result of an embodiment compared with a prior art example;

FIG. 6 is an example of a step of the present method, in accordance with some embodiments;

FIGS. 7-13 are examples of results of the present method, in accordance with some embodiments; and

FIG. 14 is a block diagram illustrating an API gravity prediction system, in accordance with some embodiments.

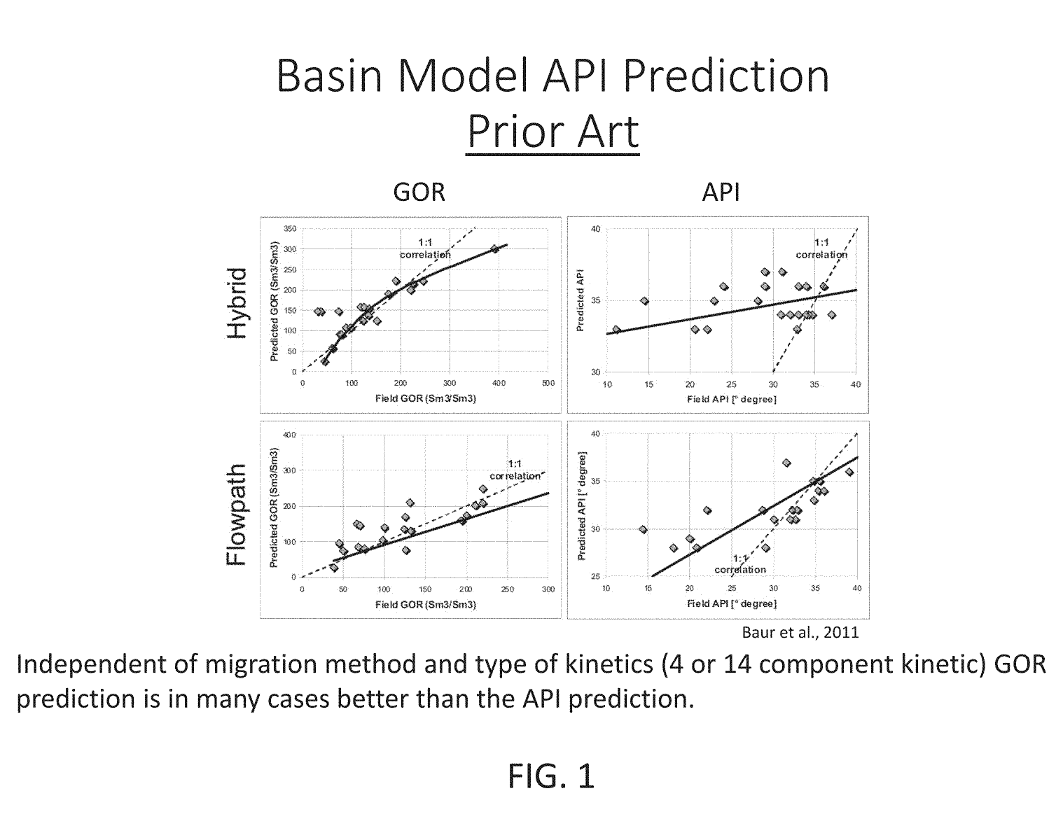

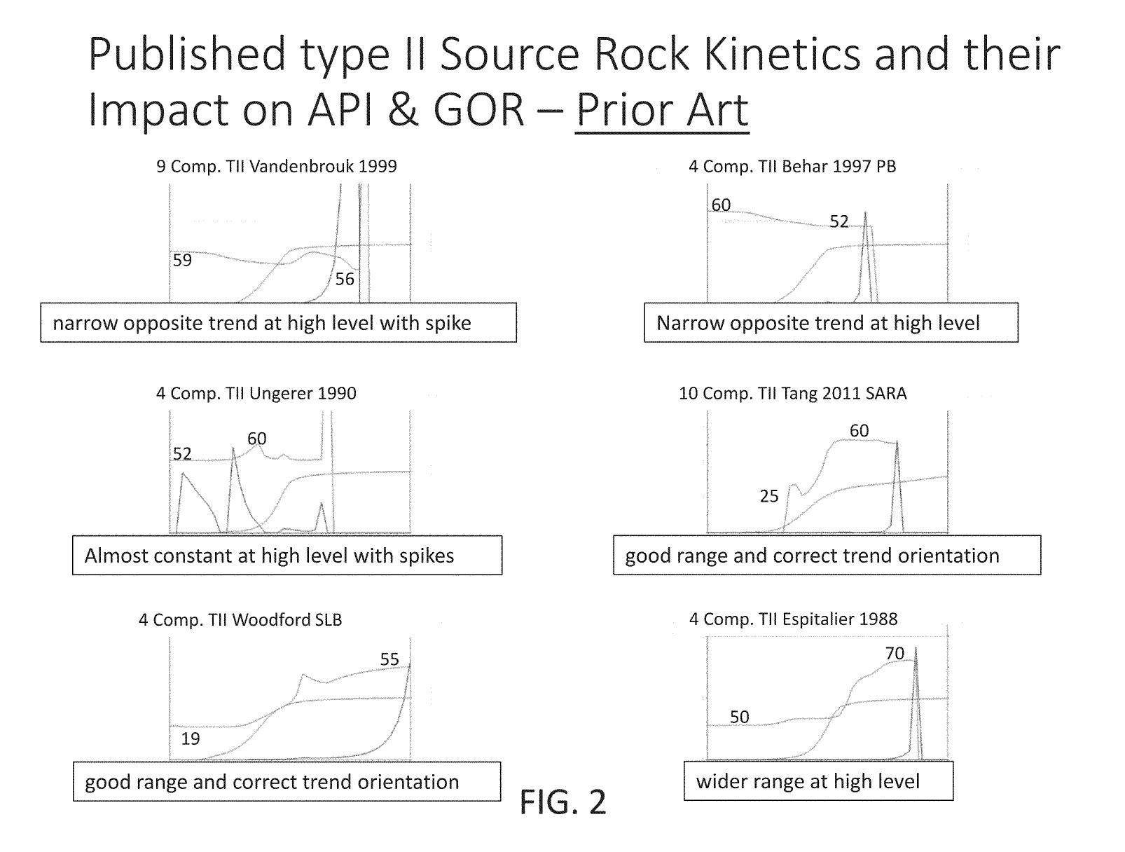

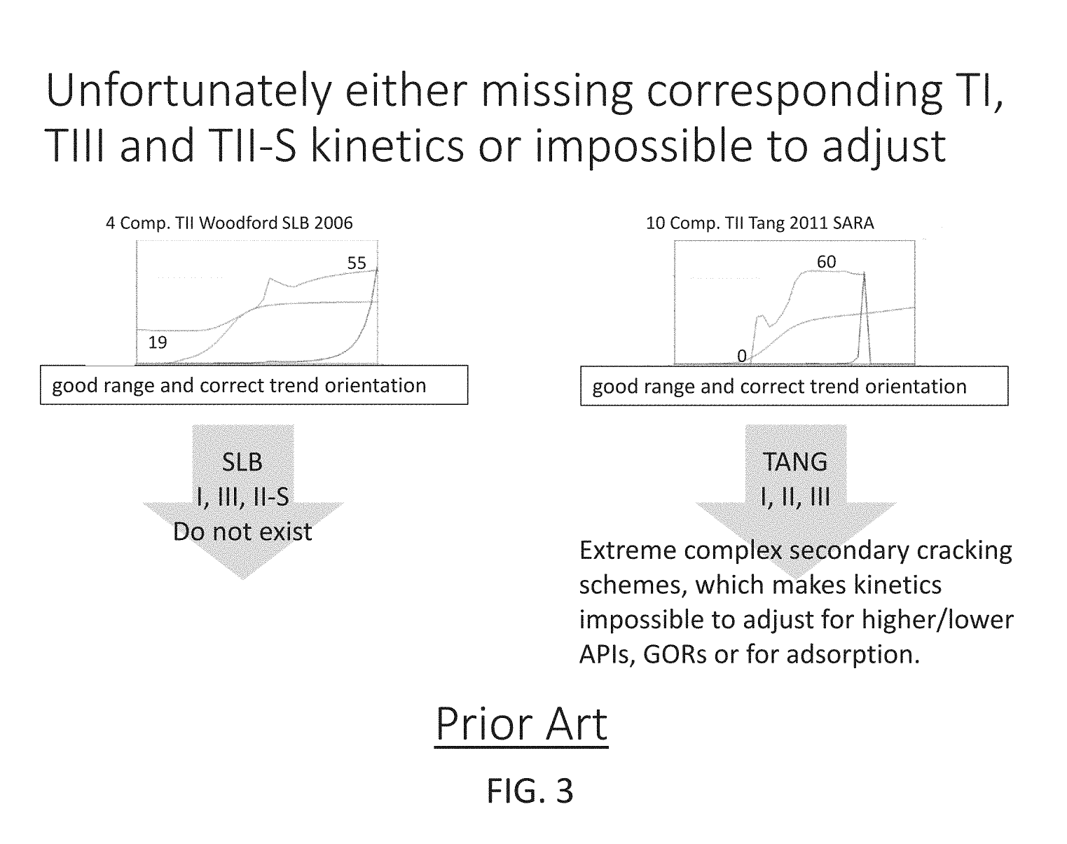

Like reference numerals refer to corresponding parts throughout the drawings.

### DETAILED DESCRIPTION OF EMBODIMENTS

Described below are methods, systems, and computer readable storage media that provide a manner of seismic imaging. These embodiments are designed to be of particular use for seismic imaging of subsurface volumes in geologically complex areas.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Five kinetic data sets representative for the standard source rock types (I, II, IIS, III and IV or A, B, C, D/E, F), which include primary and secondary cracking schemes and use a simple and adjustable adsorption model, were established. The kinetics use two oil pseudo components and two gas pseudo components. The ratio between pseudo components at 100% transformation ratio represent average ratios from public and proprietary kinetic data. The oil and gas pseudo components are generated following Gaussian distributions for their activation energies. Peak generation occurs at a lower activation energy for the heavier oil pseudo component (low API gravity) and occurs at higher activation energy for the peak generation for the lighter oil pseudo component (high API gravity). This systematic shift of activation energies allows a constant change in the API gravity of the primary generated hydrocarbons. The initial API gravity and range is determined through the molecular weight of the two oil pseudo components. These 5 kinetics calculate hydrocarbons with geological reasonable API gravity ranges and can be adjusted easily to be calibrated to source specific API gravity values. The kinetics have been shown to work when applied to conventional case studies with complex API gravity distributions (vertically stacked and not effected by any secondary processes such as biodegradation). An adsorption scheme was applied where the adsorbed hydrocarbons have the same API gravities as the expelled one. The adsorbed API gravity changes therefore with maturity. The overall amount of adsorbed hydrocarbons can be independently determined and does not influence the previously defined API gravity development. This makes the kinetics flexible enough to apply to unconventional resource assessment studies.

In addition a simple workflow is suggested to convert source rock specific bulk kinetics into API gravity predicting source rock specific kinetics. This is done by defining four pseudo components according to the average concept mentioned above and applying a shift to the bulk measured activation energy distribution according to the molecular weight. The result is that the heavy pseudo components are generated early and that lighter pseudo components are generated later. This maintains the general character of the source rocks but integrates the ability to predict APIs.

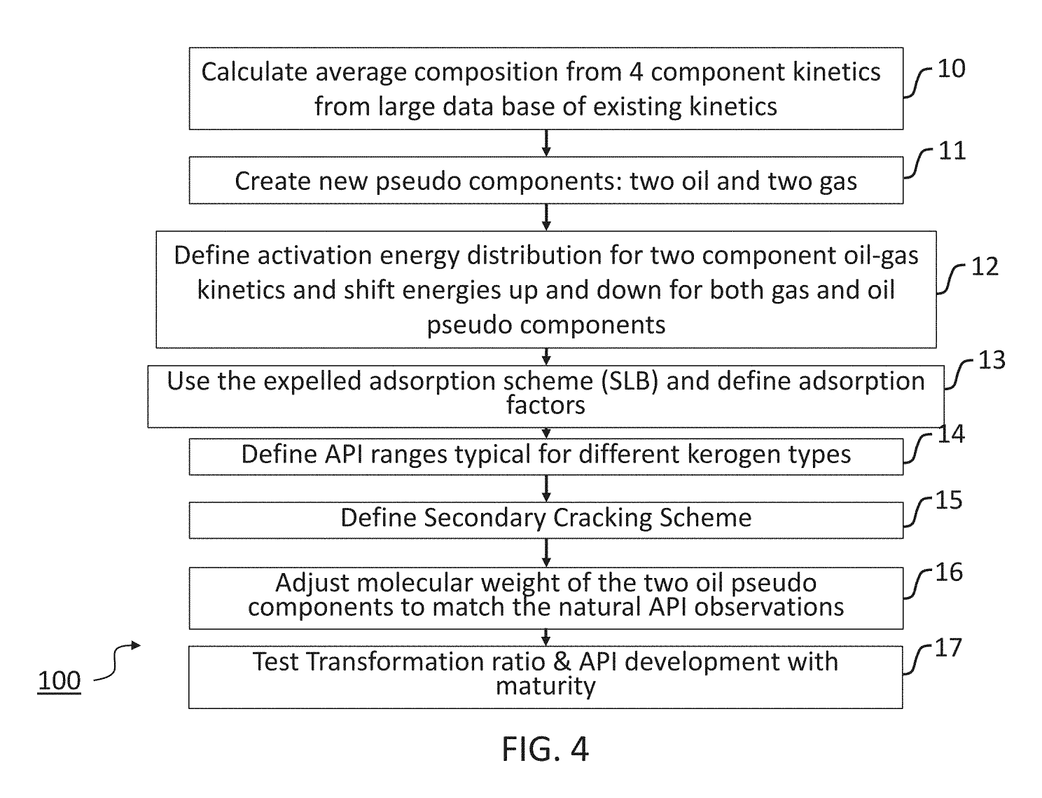

FIG. 4 illustrates a flowchart of a method 100 for predicting API gravity. At operation 10, an average composition from 4 component kinetics is calculated from a large database of existing kinetics. Those of skill in the art are aware of such databases.

At operation 11, new pseudo-components (PK) are created, two pseudo-components for gas and two for oil. These may be created within a library of components such as that embedded in Schlumberger's Petromod.

At operation 12, the method defines activation energy distributions for two component oil-gas kinetics. In a first step, the general activation energy distributions for oil and gas are determined specific for the source rock type. In a second step these two distribution are both shifted up and assigned to the lighter pseudo oil or gas component and then shifted down and assigned to the heavier oil or gas pseudo component. The activation energy distributions are generated while keeping the frequency factor for all four components constant.

At operation 13, adsorption is accounted for using an adsorption scheme such as, but not limited to, Schlumberger's scheme and adsorption factors are defined specific for the different kerogen types and the different pseudo components.

At operation 14, API ranges are defined for different kerogen types. This may be done, for example, based on published API data and/or an in-house database, which shows what API ranges are typical for different kerogen types.

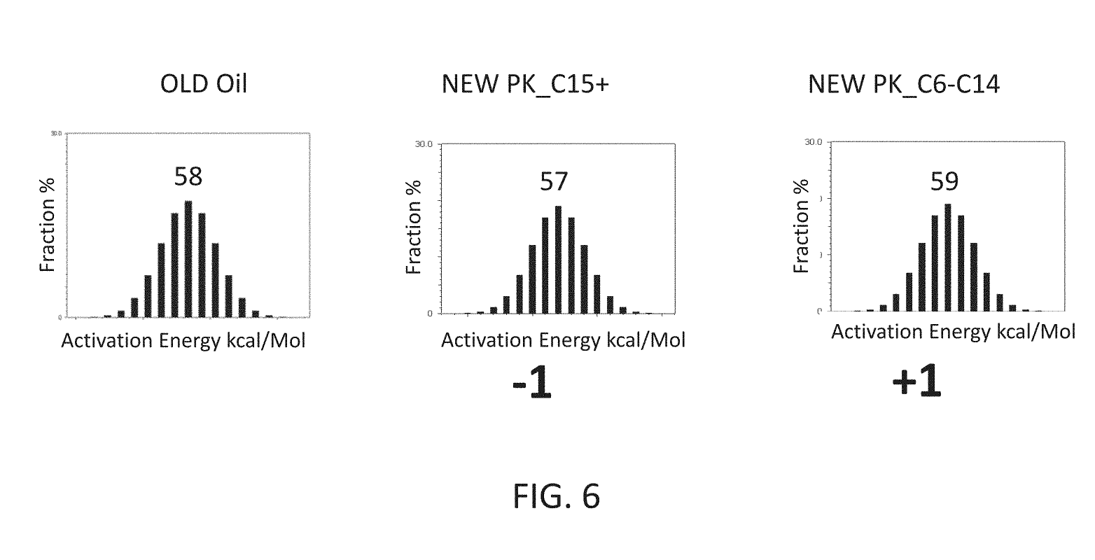

At operation 15, a secondary cracking scheme is defined. In an embodiment, this may be the Pepper & Dodd 1995 scheme. Since the present method uses two oil pseudo components, two cracking schemes are needed. This may be accomplished, for example, by using the Pepper & Corvi scheme and shifting the activation energies up one and down one, similar to what was done for the primary generation in operation 12. This is demonstrated in FIG. 6. The OLD Oil panel shows the original peak at 58, the NEW PK_C15+ has a peak at 57, and the NEW PK_C6-C14 has a peak at 59. Note that in an embodiment, methane and C2-C5 is assumed not to cracked. The activation energies for the secondary cracking scheme are defined so that average expelled gas oil ratios from large data bases and for different source rock types are matched. The activation energies for the secondary cracking are shifted up for a lighter oil component and down for a heavier oil component.

At operation 16, the method adjusts molecular weight of the two oil pseudo components to fine-tune and calibrate to specific naturally observed APIs.

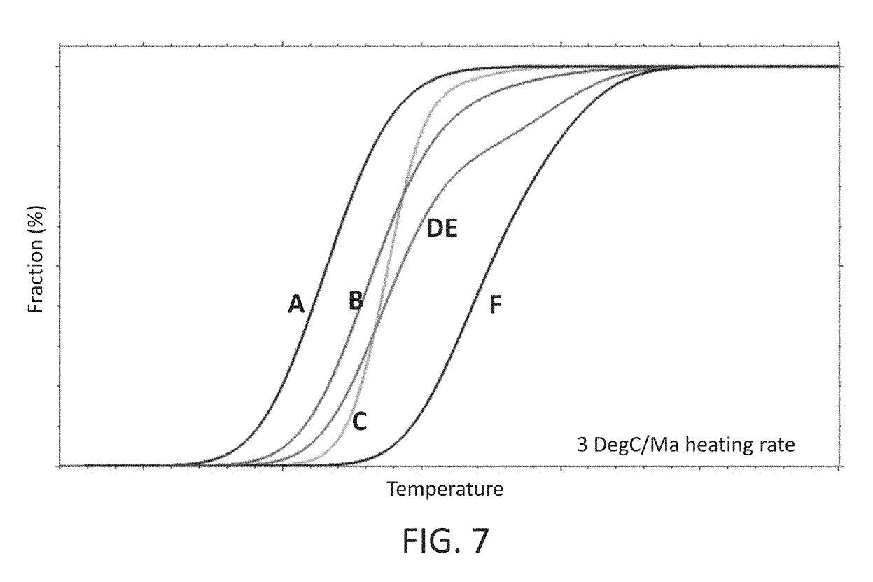

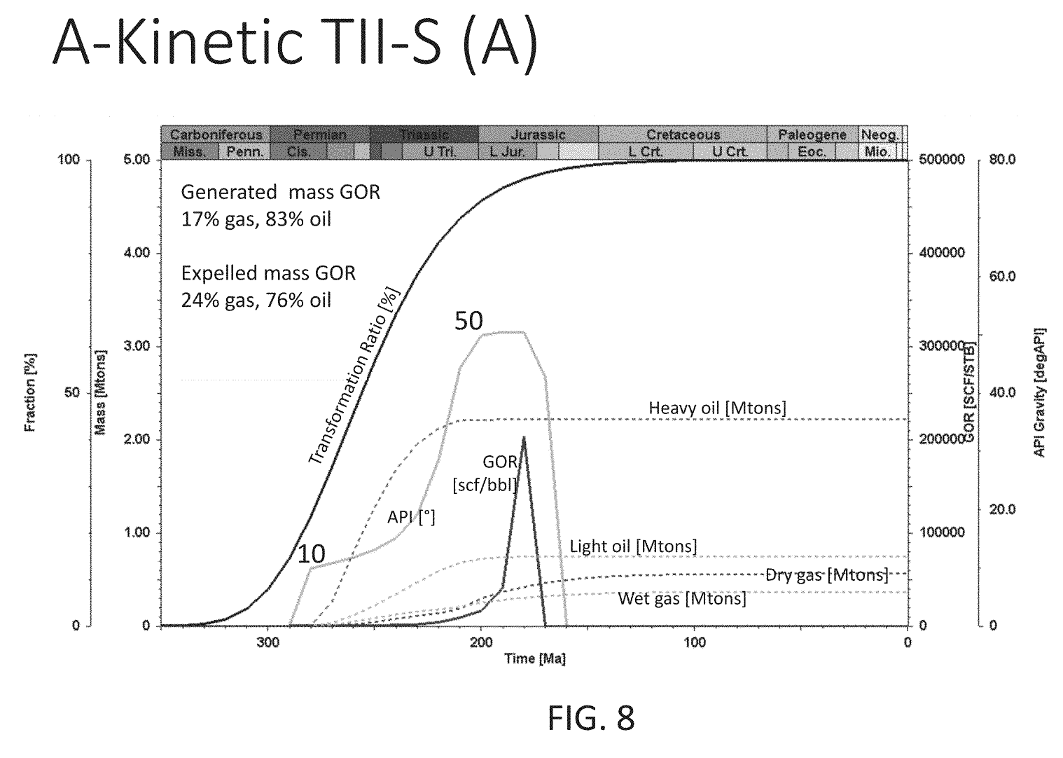

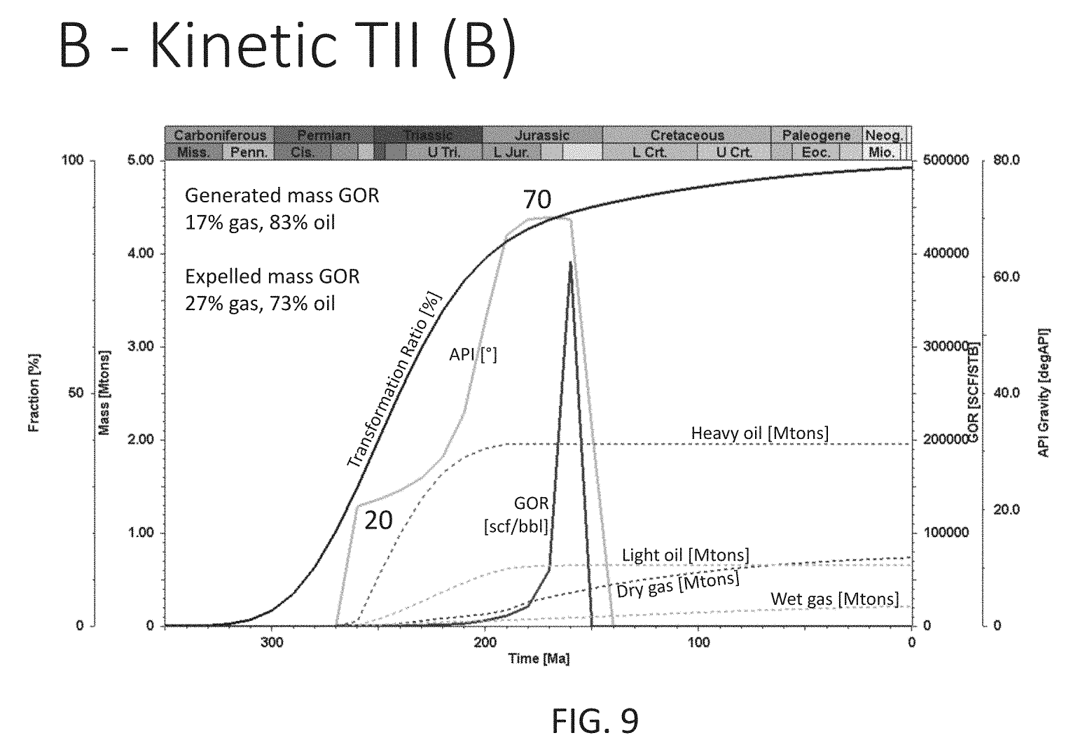

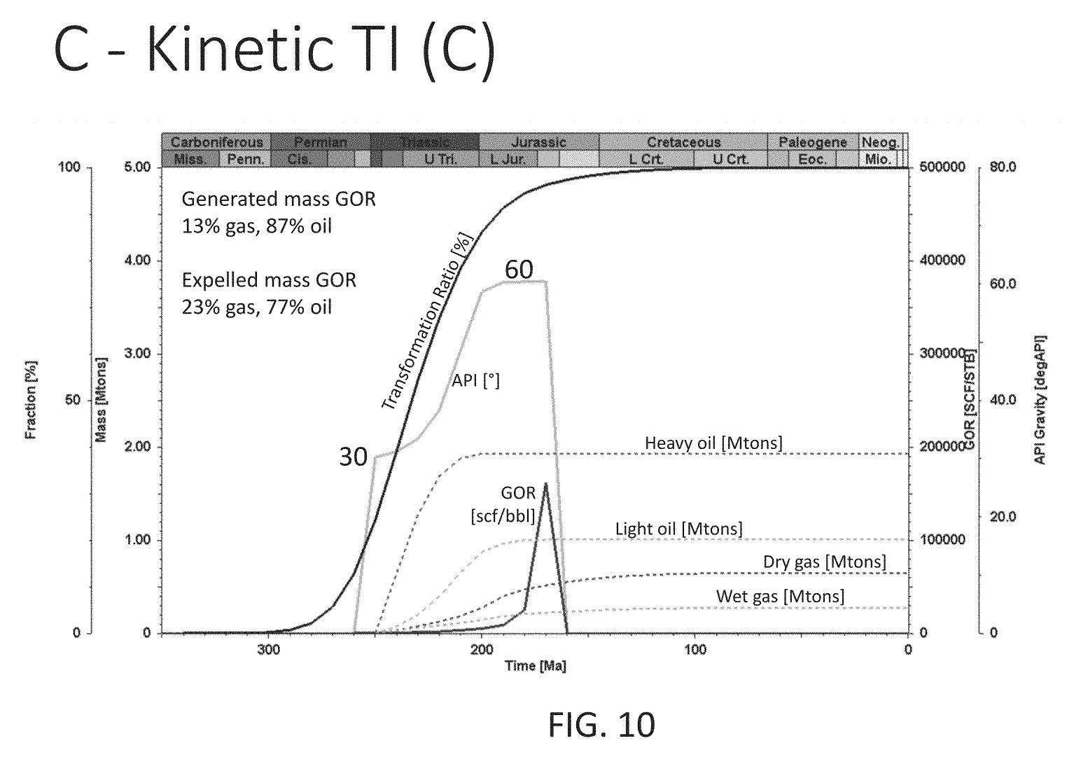

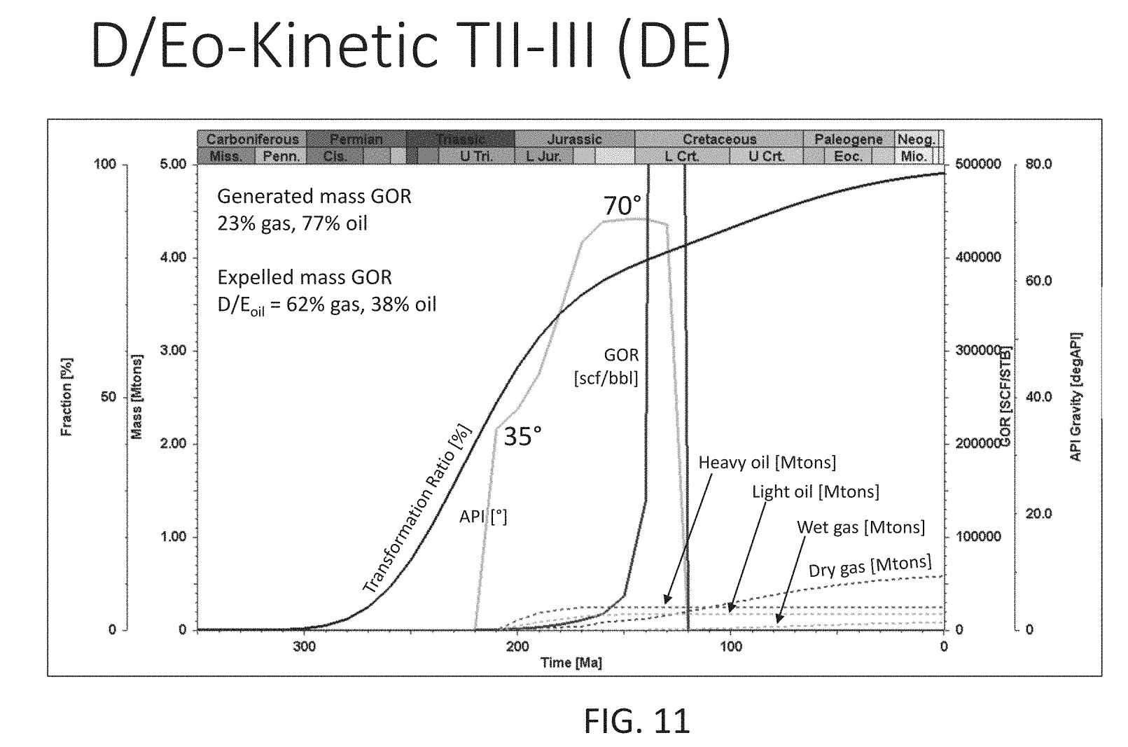

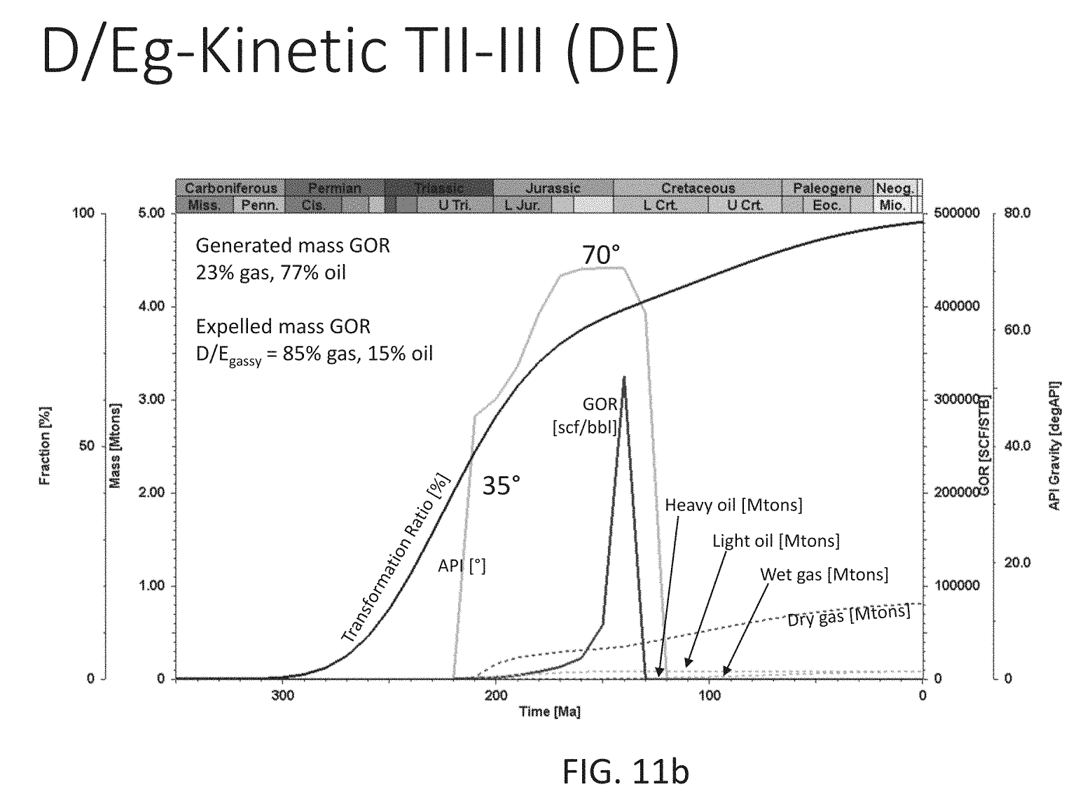

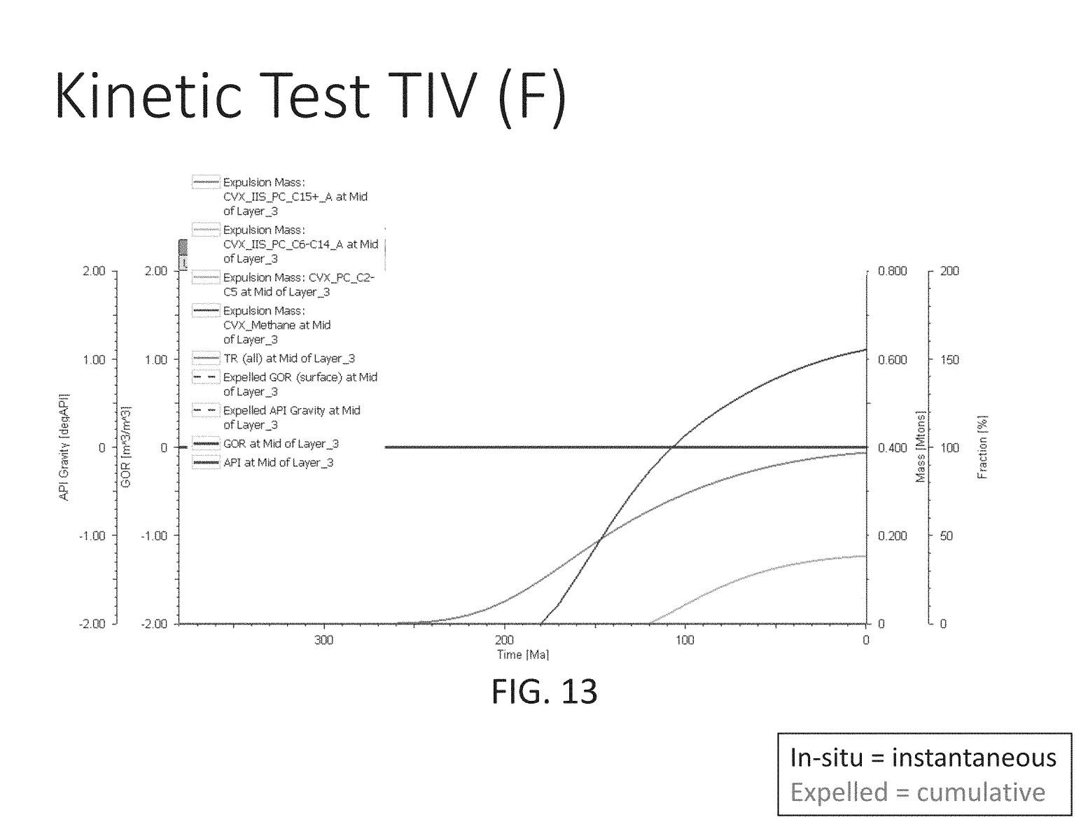

The transformation ratio is tested at operation 17. Examples of transformation ratios may be seen in FIG. 7. Also, the API development with Transformation ratio is tested. Examples may be seen in FIGS. 8 to 12.

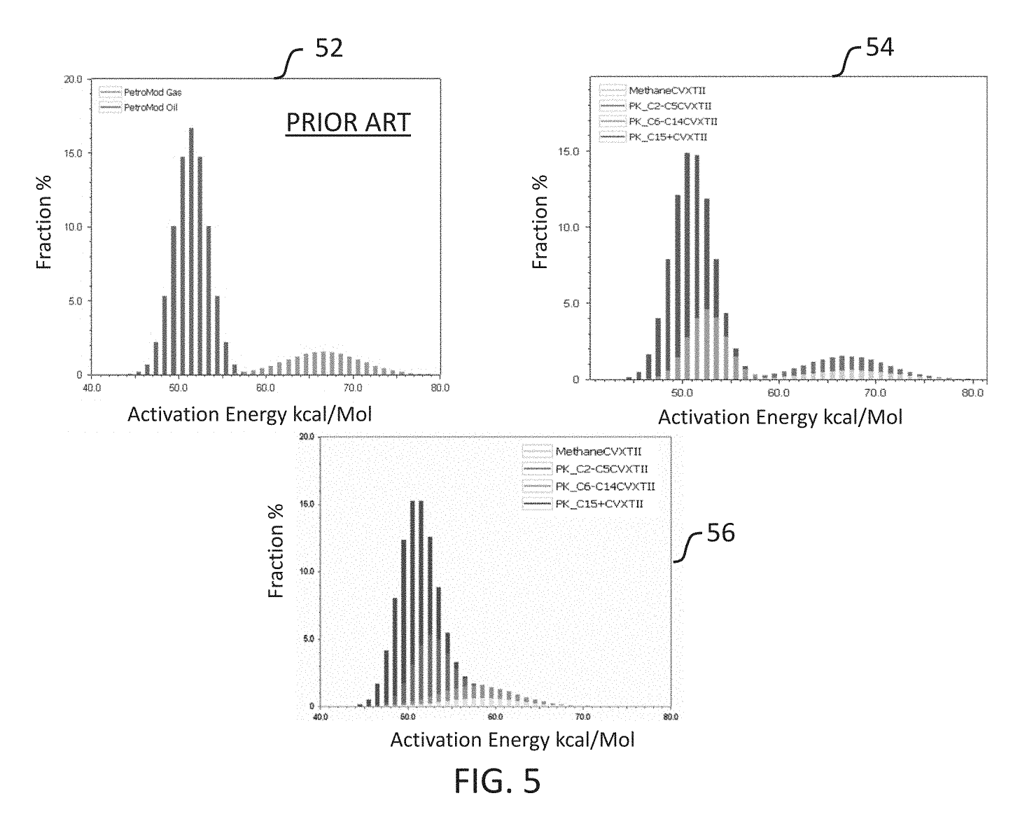

FIG. 5 compares the prior art method with two steps of the present invention. The prior art in panel 52 only has activation energy distributions for gas (light grey) and oil (dark grey). The present invention results in at least four activation energy distributions as shown in panels 54 and 56 (which has included the step of keeping the frequency factor for all four components constant).

After the kinetics have been generated to produce more accurate API ranges, an geological test model may be used to demonstrate correct ranges of API for different source rock types also in an geological environment where oil and gas is generated in four dimensions (over millions of years and three dimensions).

More accurate prediction of API gravity of the hydrocarbons in the subsurface directly contributes to budgetary planning, obtaining mineral and lease rights, signing well commitments, permitting rig locations, designing well paths and drilling strategy, and selecting and purchasing appropriate completion and production equipment.

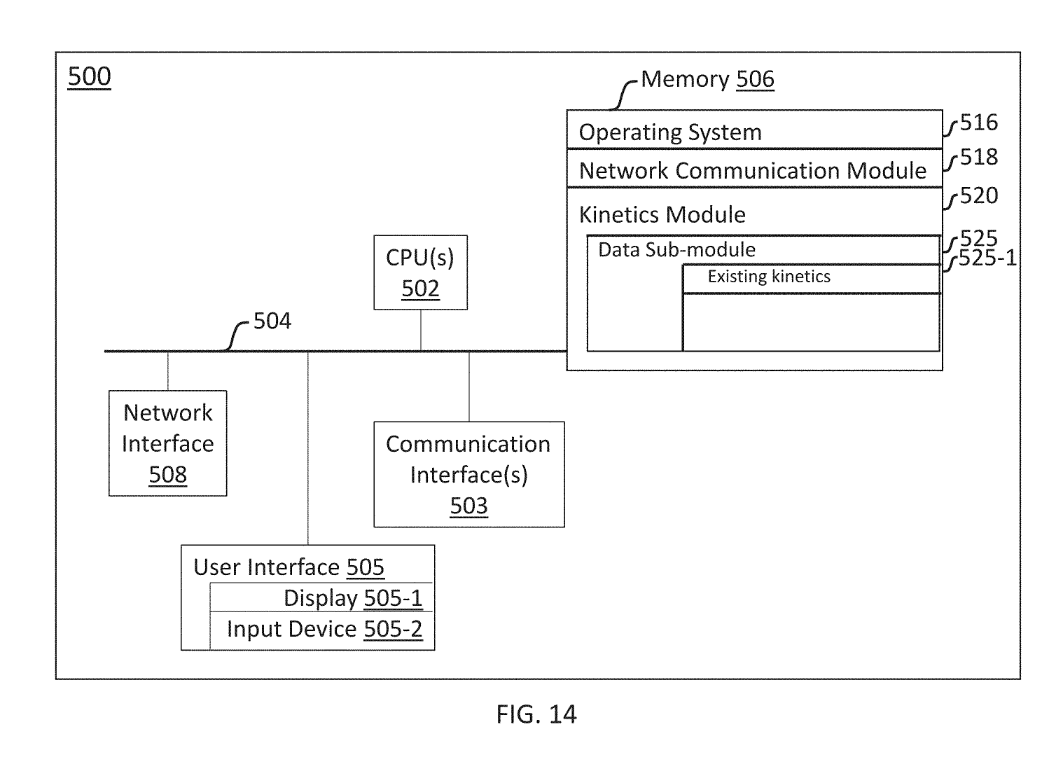

FIG. 14 is a block diagram illustrating a API gravity prediction system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the API gravity prediction system 500 includes one or more processing units (CPUs) 502, one or more network interfaces 508 and/or other communications interfaces 503, memory 506, and one or more communication buses 504 for interconnecting these and various other components. The API gravity prediction system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store seismic data, velocity models, seismic images, and/or geologic structure information.

In some embodiments, memory 506 or the non-transitory computer readable storage medium of memory 506 stores the following programs, modules and data structures, or a subset thereof including an operating system 516, a network communication module 518, and a seismic imaging module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, kinetics module 520 executes the operations of method 100. Kinetics module 520 may include data sub-module 525, which handles a database of existing kinetics 525-1. This data is supplied by data sub-module 525 to other sub-modules.

Any of the modules may optionally be able to generate a display that would be sent to and shown on the user interface display 505-1. In addition, any of the seismic data or processed seismic data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 14) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

### REFERENCES

Abu-Ali, M. A., Rudkiewicz, J. L., McGillivray, J. G. & Behar, F. (1999): Paleozoic Petroleum System of Central Saudi Arabia.—GeoArabia, Vol. 4, No. 3, pp. 321-336.
Baur, F, R. di Primio, C. Lampe, R. Littke (2011): Mass balance calculation for different models of hydrocarbon migration in the Jeanne D'Arc basin, offshore Newfoundland. Journal of Petroleum Geology, Vol 34 (2), April, pp. 181-198
Behar, F., Vandenbroucke, M., Tang, Y., Marquis, F. & Espitalie, J. (1997): Thermal cracking of kerogen in open and closed systems: determination of kinetic parameters and stoichiometric coefficients for oil and gas generation.—Org. Geochem. Vol. 26, No. 5/6, pp. 321-339.
Braun, R. & Burnham, A.; (1991): PMOD: a flexible model of oil and gas generation cracking, and expulsion. Advances in organic geochemistry, Vol. 19, Now 1-3, pp. 161-172, 1992.
COOLES, G. P., MACKENZIE, A. S. and QUIGLEY, T. M., 1986. Calculation of petroleum masses generated and expelled from source rocks. Organic Geochemistry, 10, 1-3, 235-245.
DiPrimio, R. & Horsfield, B. (2006): From petroleum-type organofacies to hydrocarbon phase prediction.—AAPG Bull. V. 90, No. 7, pp. 1031-1058.
Espitalie, J., Ungerer, P., Irwin, I. & Marquis, F. (1988): Primary Cracking of kerogens. Experimenting and modeling C1, C2-C5, C6-C15 and C15+ classes of hydrocarbons formed.—Advances in Organic Geochemistry, Vol. 13, Nos 4-6, pp. 893-899
PEPPER, A. S. and J. CORVI, 1995. Simple kinetic models of petroleum formation. Part 1. Oil and gas generation from kerogen. Marine and Petroleum Geology, 12, 291-319.
HANTSCHEL, T., KAUERAUF, A. I. and WYGRALA, B., 2000. Finite element analysis and ray tracing modeling of petroleum migration. Marine and Petroleum Geology, 17, 7, 815-820.
Khavari-Khorasani G., Dolson, J. C., Michelsen, J. K. (1998): The factors controlling the abundance and migration of heavy versus light oils, as constrained by data from the Gulf of Suez. Part I. The effect of expelled petroleum composition, PVT properties and petroleum system geometry, Organic Geochemistry, Vol 29., No. 1-3, pp. 255-282.
PEPPER, A. S. and DODD, T. A. 1995. Simple kinetic models of petroleum formation. Part II: oil-gas cracking. Marine and Petroleum Geology 12, 321-340.
Tang, Y., Jenden, P. D., Nigrini, A. S. & Teerman, S. C. Modeling Early Methane Generation in Coal, ENERGY & FUELS, 1996, 10(3) 659-671.
PETERS, K. E., 1986. Guidelines for evaluating petroleum source rock using programmed pyrolysis. AAPG Bulletin 70, 318-329.
Sandvik E. I., Young W. A., Curry D. J. (1991): Advances in Organic Geochmistry, Vol 19., Nos 1-3, pp. 77-87, 1992
Stainforth, J. G. (2009): Practical kinetic modeling of petroleum generation and expulsion, Marine and Petroleum Geology, Vol. 26, pp. 552-572.
Ungerer, P. (1990): State of the art of research in kinetic modelling of oil formation and expulsion.—Org. Geochem. Vol. 16, Nos 1-3, pp. 1-25
Vandenbroucke, M., Behar, F. & Rudkiewicz, J. L. (1999): Kinetic modelling of petroleum formation and cracking: implications from the high pressure/high temperature Elgin Field (UK, North Sea).—Org. Geoch. Vol. 30, pp. 1105-1125.

What is claimed is:

1. A computer-implemented method, comprising:
a. receiving, at a computer processor, values from a database of existing kinetics to calculate average kinetics;
b. creating, via the computer processor, at least two oil pseudo-components and at least two gas pseudo-components based on the average kinetics;
c. defining, via the computer processor, activation energy distributions for two component oil-gas kinetics based on the average kinetics and shifting the activation energy distributions up and down based on the at least two oil pseudo-components and the at least two gas pseudo-components to generate a new set of activation energy distributions, wherein the new set of activation energy distributions is generated while keeping frequency factors for the at least two oil pseudo-components and the at least two gas pseudo-components constant;
d. defining, via the computer processor, adsorption factors for the new set of activation energy distributions;
e. defining, via the computer processor, API (American Petroleum Institute) ranges for different kerogen types;
f. defining, via the computer processor, activation energies for a secondary cracking scheme so that average expelled gas oil ratios from large data bases and for different source rock types are matched, wherein the activation energies for the secondary cracking are shifted up for a lighter oil component and down for a heavier oil component;
g. adjusting, via the computer processor, molecular weights of the at least two oil pseudo-components based on measured API values; and
h. simulating, via the computer processor, transformation ratio and API development of kerogens with maturity.

2. The method of claim 1 further comprising using the transformation ratio and API development to assess actual hydrocarbon reservoirs.

3. The method of claim 1 further comprising calculating, via the computer processor, one or more of gas-oil ratio (GOR) and condensate-gas ratio (CGR) based on the transformation ratio and the API development.
